(19) United States
(12) Patent Application Publication
(10) Pub. No.: US 2019/0389293 A1
(43) Pub. Date: Dec. 26, 2019

(54) VEHICLE REAR SLIDER WINDOW ASSEMBLY WITH HOTMELT RAIL ATTACHMENT

(71) Applicant: MAGNA MIRRORS OF AMERICA, INC., Holland, MI (US)

(72) Inventor: Edward B. Scott, Rockford, MI (US)

(21) Appl. No.: 16/446,665

(22) Filed: Jun. 20, 2019

Related U.S. Application Data
(60) Provisional application No. 62/688,531, filed on Jun. 22, 2018.

(51) Int. Cl. B60J 10/76; B60J 1/18; B60J 10/00

(52) U.S. Cl. CPC B60J 10/76; C09J 175/04; B60J 10/45; B60J 1/1853

(57) ABSTRACT

A vehicular slider window assembly includes at least one fixed window panel that defines an opening, an upper rail and a lower rail attached at the at least one fixed window panel, and a movable window panel that is movable along the upper rail and the lower rail. The movable window panel is movable between a closed position and an opened position. Each of the upper and lower rails comprises a recess for receiving adhesive therein. The recess is established along an attaching surface of the respective one of the upper and lower rails with a wall of the respective one of the upper and lower rails at least partially circumscribing the recess. The upper and lower rails are adhesively attached at the at least one fixed window panel via hotmelt adhesive dispensed at and along the respective recesses.

### CROSS REFERENCE TO RELATED APPLICATION

The present application claims the filing benefits of U.S. provisional application Ser. No. 62/688,531, filed Jun. 22, 2018, which is hereby incorporated herein by reference in its entirety.

### FIELD OF THE INVENTION

The present invention relates to a slider window assembly for a vehicle and, more particularly, a rear slider window assembly for a vehicle and, more particularly, a rear slider window assembly for a pickup truck or the like.

### BACKGROUND OF THE INVENTION

It is known to provide a slider window assembly for an opening of a vehicle, such as a rear slider window assembly for a rear opening of a pickup truck. Conventional slider window assemblies for rear openings of trucks or the like typically include three or more panels, such as two fixed window panels and a slidable window panel. The slidable window panel is supported by rails that may be adhesively bonded at the surface of the fixed window panels. The slidable window panel may be moved along the rails to open and close the window. The slidable window panel may be driven or moved by a cable drive system.

### SUMMARY OF THE INVENTION

The present invention provides a rear slider window assembly that has upper and lower rails or channels adhesively bonded at the inner surface of the fixed window panel or panels via a reactive hotmelt urethane adhesive. The reactive hotmelt urethane adhesive bonds the rails to the fixed window panel(s) and can achieve a thinner bond line (and thus a lower profile window assembly). Also, the reactive hotmelt urethane adhesive cures or cools to a strong bond quickly so that the window panel and rails do not have to be fixtured for a long period of time after the adhesive is dispensed.

These and other objects, advantages, purposes and features of the present invention will become apparent upon review of the following specification in conjunction with the drawings.

### BRIEF DESCRIPTION OF THE DRAWINGS

FIG. 1 is a rear perspective view of a pickup truck having a rear slider window assembly in accordance with the present invention;

FIG. 2 is a perspective view of the rear slider window assembly having upper and lower rails bonded at the glass panels in accordance with the present invention;

FIG. 3 is a sectional view of a lower rail attached at a fixed window panel of a vehicular window assembly via a hotmelt adhesive;

FIG. 4 is a sectional view of a movable window panel attached at a carrier of a vehicular window assembly via a hotmelt adhesive;

FIG. 5 is a sectional view of a latch element that is attached at a window panel of a vehicular window assembly via a hotmelt adhesive; and

FIG. 6 is a sectional view of a catch base or element that is attached at a window panel of a vehicular window assembly via a hotmelt adhesive.

### DESCRIPTION OF THE PREFERRED EMBODIMENTS

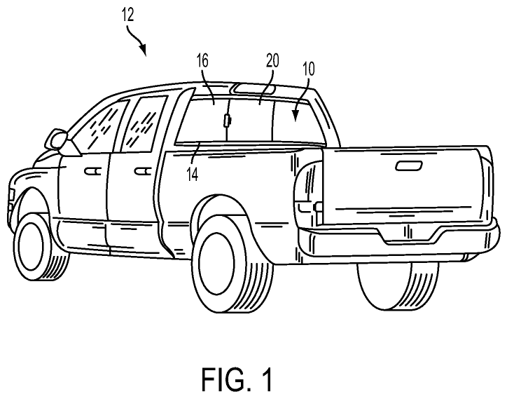

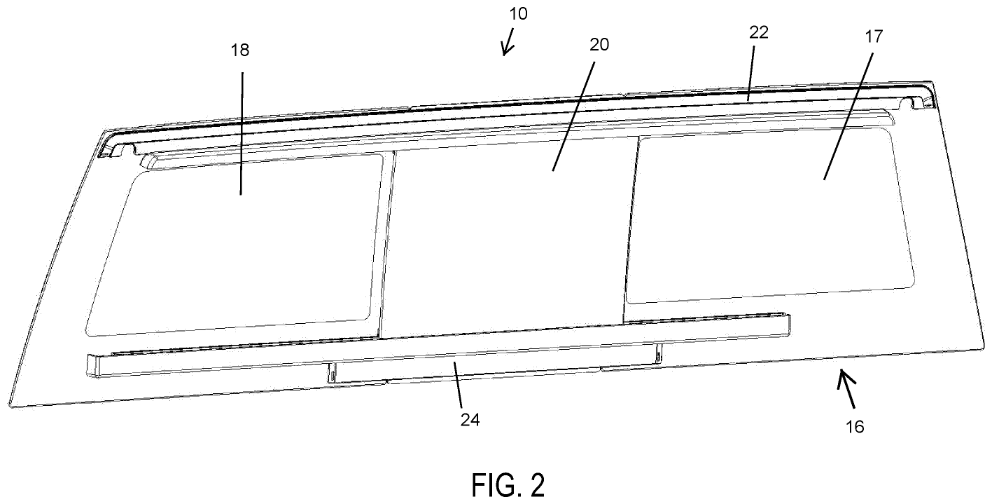

Referring now to the drawings and the illustrative embodiments depicted therein, a rear slider window assembly 10 of a vehicle 12 (such as a pickup truck or the like) includes at least one fixed window panel 16 (which may comprise a single fixed window panel with an opening therethrough or which may comprise a pair of spaced apart fixed window panels 17, 18 having an opening established therebetween), and a movable window panel 20 that is movable relative to a frame or rails 22, 24 and the fixed window panel(s) 16 between an opened position and a closed position (FIGS. 1-3). The rails include an upper rail 22 and a lower rail 24, with the upper and lower edge regions of movable window panel 20 (FIG. 1) movably or slidably received in and along the respective upper and lower rails 22, 24. The rails 22, 24 are adhesively bonded to the inner surface of the window panel via a hotmelt adhesive.

The window assembly may comprise a hole-in-glass window configuration, where the single fixed glass panel has an aperture or hole or opening established therethrough to define separate spaced apart fixed window panels or panel portions. The window assembly may utilize aspects of the window assemblies described in U.S. Pat. Nos. 8,915,018 and/or 8,881,458, and/or such as described in U.S. Publication Nos. US-2017-0144511 and/or US-2003-0213179, which are all hereby incorporated herein by reference in their entireties. Optionally, the window assembly may comprise two fixed window panels or panel portions that are spaced apart so as to define an opening therebetween (and with upper and lower appliqués or trim or filler panels or elements disposed at the upper and lower regions of the opening and between the fixed window panels).

Upper and lower rails 22, 24 may comprise any suitable channel or rail element configured to slidably receive an upper or lower edge portion of the movable window panel. Slider or movable window panel 20 is movable along lower rail 24 and upper rail 22 of frame portion 14 to open and close the aperture or opening, such as in a manner similar to known slider window assemblies. The movable window panel 20 may include or may be disposed at a lower carrier, which may receive the lower perimeter edge region of the slider window panel 20 therein and is slidably or movably received in the channel portion of the lower rail 24 of frame portion 14.

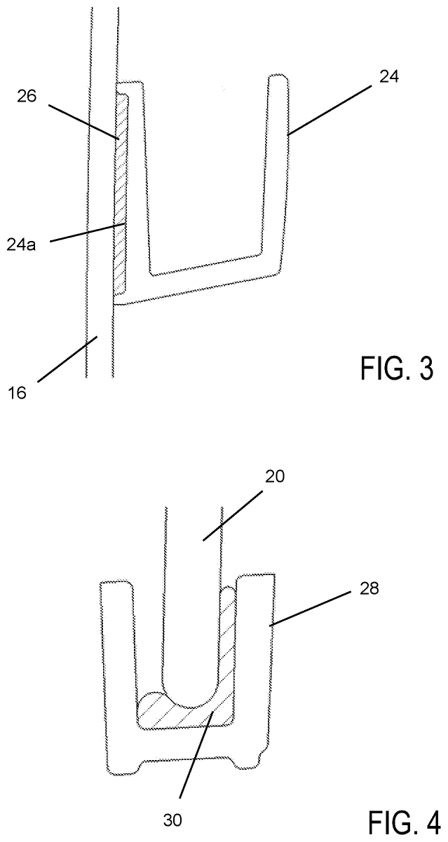

The rails include a recess or channel at its window facing side or surface and include side walls surrounding or circumscribing and defining the recess. The recess is configured to receive the hotmelt adhesive therein for adhesively bonding the rails at the fixed window panel, and the walls set or establish the bond-line thickness of the adhesive that bonds the rail at the window panel or panels. As shown in FIG. 3, the lower rail 24 has a recess 24a with hotmelt adhesive 26 dispensed therein so as to engage and adhere to both the lower rail 24 and the surface of the glass window panel 16. Thus, when the adhesive is dispensed along and in the recess of the upper rail, the upper rail is pressed against the window surface, with the walls engaging the window surface and the adhesive bonding the rail to the window.

The hotmelt adhesive comprises a reactive hotmelt urethane adhesive (such as a 1 K reactive hotmelt urethane adhesive), which provides faster cure times. The uncured hotmelt adhesive can be dispensed between surfaces (such as between the glass window panel surface and the plastic rail surface) for faster processing times and for faster processing time, and may be dispensed on insulated surfaces like plastics and then mated to glass or metal surface for faster cooling times or faster processing time. This equates to reduced fixture time and provides for making a part or component or assembly faster and more efficiently. For example, the dispensed uncured adhesive may partially cure to a solidified and/or hardened state, which is around 60 percent to 80 percent (or more) of its ultimate bond strength, in a very short time, such as less than about five minutes, or less than about three minutes or less than about one minute, following pressing of the components (with the hotmelt adhesive disposed therebetween) together.

Another benefit is the speed of handling and assembly of the rest of the window assembly. This can happen due to the almost immediate nearly full bond strength (provided by the hotmelt adhesive when initially cooled/cured), which is provided in about a minute (e.g., less than five minutes, preferably less than two minutes and preferably less than one minute) versus the 20 minutes that is required for the known and used two component (1.5 K) urethane system or three plus hours for known and used 1 K urethane systems or known two component silicones. The curing process comprises a moisture cure process, but the fast set/high green strength of the hotmelt adhesive (or handling strength of the hotmelt adhesive, where the adhesive is cured or hardened to a solidified state that provides sufficient bond strength to hold the component at the panel for movement and further processing/handling of the assembly) is attributed to the hotmelt part of the adhesive compound.

The hotmelt adhesive also provides for a thinner bond line (shallower recess in the rails or other components). The thinner bond line allows for faster cooling. Thus, the hotmelt adhesive bond requires less material, and results in a thinner overall thickness of the window assembly, which is significant in the packaging aspect of windows and especially a rear slider. For example, the bond line thickness of the hotmelt adhesive may be less than 1.5 mm, and may be less than 1 mm, such as around 0.7 mm or thereabouts.

An additional benefit is primerless adhesion to the plastic PC/ABS rails and other components (such as an appliqué), which will reduce cost, labor and time for window assembly. Another benefit of the use of hotmelt adhesive of the present invention is reduced water leaks paths between the rail and the glass and in and around the seal.

When using the reactive hotmelt adhesive, the adhesive allows for enhanced fixturing/better location and enhanced holding power. Thus, components stay in the place where they are put. The greater initial (green) strength of the hotmelt adhesive bond can overcome concerns such as molding warp of plastic parts.

Another benefit of this material is that it does not sag prior to cure, even in heat or when exposed to elevated temperatures. The parts are fixtured or placed together, cooled and stay in place even when exposed to higher temperatures (as opposed to other adhesives used that require fixturing or holding in place for cure so they don't move).

The hotmelt adhesive may comprise a reactive hotmelt urethane adhesive, such as ADZ-1357, commercially available from Adhezion. Optionally, Adhezion's NP-2075VF-149 (a reactive one-component hotmelt adhesive) may be used. Such adhesives are designed for and used for acrylic bonding (e.g., headlamp sealant).

Therefore, the present invention provides enhanced assembly or bonding of the upper and lower rails to the fixed window panel or panels. By using a reactive hotmelt urethane adhesive to bond the rails to the fixed window panel(s), a thinner bond line may be achieved (and thus a lower or reduced profile window assembly). Also, the reactive hotmelt urethane adhesive cures or cools to a strong bond quickly so that the window panel and rails do not have to be fixtured for a long period of time after the adhesive is dispensed.

Additional areas of opportunity/use of the reactive hotmelt adhesive include, for example, center glass bonding of a rear slider carrier 28 to the primed movable glass panel 20, with the lower perimeter edge region of the movable panel 20 received in a channel of the carrier 28 and bonded therein via hotmelt adhesive 30, such as shown in FIG. 4. The carrier (with the glass panel bonded thereto) is slidably received in the lower rail, with an upper region of the window panel received in the upper rail.

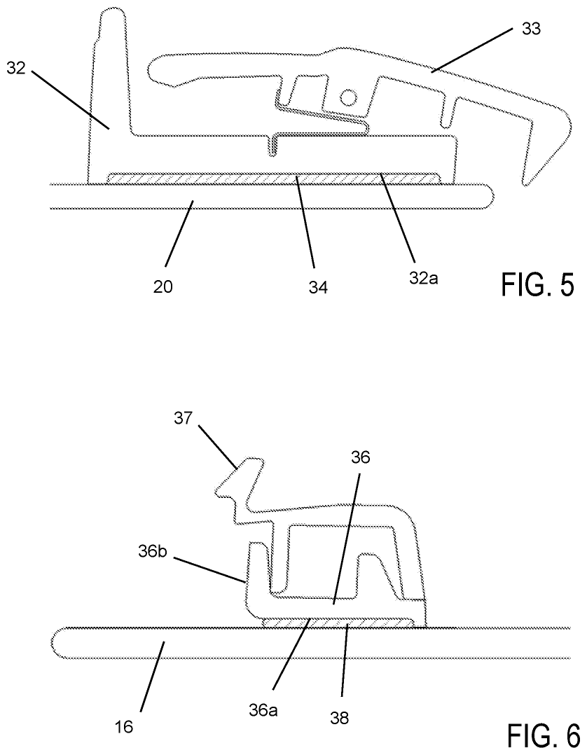

Optionally, one or more brackets may be bonded to primed glass via the hotmelt adhesive. The brackets may comprise plastic or metal or e-coated components. For example, the brackets may comprise a center glass panel latch base 32 (made from, for example, polycarbonate (PC)/ABS and/or glass filled nylon or the like) bonded to the movable window panel 20 via hotmelt adhesive 34 dispensed in its uncured form at or in a recess 32a of the latch base 32 so as to engage and bond (when at least partially cured) to the latch base 32 and the surface of the panel 20, such as shown in FIG. 5, and a catch base 36 (made from, for example, PC/ABS or the like) bonded to the fixed window panel 16 via the hotmelt adhesive 38 dispensed in its uncured state at or in a recess 36a of the catch base 32 so as to engage and bond (when at least partially cured) to the catch base 36 and the surface of the panel 16, such as shown in FIG. 6. The pivoting latch element 33 (pivotally mounted at the latch base 32 at the movable window panel) engages an engaging or latching portion 37 at the catch base 36 when the center glass panel or movable panel is closed and stops at the fixed window panel catch base (such as when the perimeter edge region of the movable panel contacts a stop surface 36b at the catch base 36.

Optionally, other applications of the reactive hotmelt adhesive include, for example, post attach bezel and/or appliqués to the window panels (whether on PVC, RIM (reaction injection molding) urethane, or glass panels directly or on other plastic such as polypropylene or the like), and fixturing small components into place without having to prime surfaces.

Optionally, a metallic bezel (such as a stainless steel bezel) may be attached to PVC with the hotmelt adhesive (such as, for example, ADZ-1357). Such attachment provides enhanced flexibility in design and curvature of the bezel and panel. The adhesion is done without primer, and with a plasma cleaning process of the metallic bezel. There is no surface preparation needed for the PVC component.

As discussed above, the upper and lower rails of a rear slider window assembly may be bonded to the fixed glass panel or panels via the hotmelt adhesive. The rails may comprise a PC/ABS material or may comprise a thermoplastic olefin (TPO) material. If a TPO material is used, the rails may be plasma treated or flame treated prior to being bonded to the panel or panels.

The movable window panel may be movable between its opened and closed positions via any suitable means, such as via manual pushing or pulling at the window panel and/or in response to actuation of a drive motor of a drive motor assembly or system, which may move cables or wires of cable assemblies relative to a sheath of the cable assemblies or the like to impart horizontal movement of the slider window panel along the rails. Optionally, the drive motor assembly may utilize aspects of the drive assemblies of the types described in U.S. Pat. Nos. 4,920,698; 4,995,195; 5,146,712; 5,531,046; 5,572,376; 6,955,009 and/or 7,073,293, and/or U.S. Publication Nos. US-2004-0020131 and/or US-2008-0127563, which are all hereby incorporated herein by reference in their entireties.

The benefits of embodiments of the slider window assembly of the present invention may also be realized in vehicular movable window assemblies other than a rear slider window assembly for a pickup truck or the like, such as (for example) a slider window assembly suitable for use as a movable side window for a vehicle such as a van or a bus. The window assembly may utilize aspects of the elements and window assemblies described in U.S. Pat. Nos. 8,915,018 and/or 8,881,458, which are hereby incorporated herein by reference in their entireties.

Although shown and described as a horizontally movable center window that moves relative to a pair of opposite side windows (such as for applications at the rear of a cab of a pickup truck or the like), it is envisioned that the present invention is applicable to other types of movable window assemblies, such as horizontally movable window panels that move relative to a single fixed window panel and/or frames (such as for a rear or side opening of a vehicle or the like), and/or such as vertically movable window panels that move relative to one or more fixed panels and/or frames (such as for a rear or side opening of a vehicle or the like), while remaining within the spirit and scope of the present invention.

Optionally, the window assembly or assemblies of the present invention may utilize aspects of the window assemblies described in U.S. Pat. Nos. 8,915,018; 8,881,458; 8,402,695; 7,073,293; 7,003,916; 6,119,401; 6,026,611; 5,996,284; 5,799,444 and/or 6,691,464, and/or U.S. Publication Nos. US-2014-0047772; US-2006-0107600; US-2008-0127563; US-2004-0020131 and/or US-2003-0213179, all of which are hereby incorporated herein by reference in their entireties.

Changes and modifications to the specifically described embodiments may be carried out without departing from the principles of the present invention, which is intended to be limited only by the scope of the appended claims, as interpreted according to the principles of patent law.

1. A vehicular slider window assembly, said vehicular slider window assembly comprising:
at least one fixed window panel, said at least one fixed window panel comprising a glass window panel and defining an opening;
an upper rail and a lower rail attached at said at least one fixed window panel;
a movable window panel that is movable along said upper rail and said lower rail, wherein said movable window panel comprises a glass window panel that is movable along said upper and lower rails between a closed position, where said movable window panel is disposed at said opening, and an opened position, where said movable window panel is disposed at least partially along said at least one fixed window panel;
wherein each of said upper and lower rails comprises a recess for receiving adhesive therein, and wherein said recess is established along an attaching surface of the respective one of said upper and lower rails with a wall of the respective one of said upper and lower rails at least partially circumscribing said recess; and
wherein said upper and lower rails are adhesively attached at said at least one fixed window panel via hotmelt adhesive dispensed in its uncured state at and along the respective recess and at least partially cured to bond said upper and lower rails at said at least one fixed window panel.

2. The vehicular slider window assembly of claim 1, wherein the hotmelt adhesive comprises a reactive hotmelt adhesive.

3. The vehicular slider window assembly of claim 1, wherein the hotmelt adhesive comprises a reactive hotmelt urethane adhesive.

4. The vehicular slider window assembly of claim 1, wherein the hotmelt adhesive comprises a reactive hotmelt one-component urethane adhesive.

5. The vehicular slider window assembly of claim 1, wherein the hotmelt adhesive comprises ADZ-1357.

6. The vehicular slider window assembly of claim 1, wherein the wall of the respective one of said upper and lower rails establishes a bond line thickness of the hotmelt adhesive.

7. The vehicular slider window assembly of claim 6, wherein the bond line thickness of the hotmelt adhesive is less than 1 mm.

8. The vehicular slider window assembly of claim 1, wherein said at least one fixed window panel comprises a single fixed window panel having an opening therethrough.

9. The vehicular slider window assembly of claim 1, wherein said at least one fixed window panel comprises first and second fixed window panels defining an opening therebetween.

10. A vehicular window assembly, said vehicular window assembly comprising:
a window panel configured to be mounted at a vehicle, said window panel comprising a glass window panel;
a window component that is attached at said window panel;
wherein said window component comprises at least one selected from the group consisting of (i) a bracket, (ii) a hinge element for hingedly attaching said window panel at the vehicle, (iii) a latch element for latching said window panel at a closed position at the vehicle, and (iv) a catch element for latching at a latch of another window panel of said vehicular window assembly;
wherein said window component comprises a recess for receiving adhesive therein, and wherein said recess is established along an attaching surface of said window component with a wall of said window component at least partially circumscribing said recess; and
wherein said window component is adhesively attached at said window panel via hotmelt adhesive dispensed in its uncured state at and along said recess and at least partially cured to bond said window component at said window panel.

11. The vehicular window assembly of claim 10, wherein the hotmelt adhesive comprises a reactive hotmelt adhesive.

12. The vehicular window assembly of claim 10, wherein the hotmelt adhesive comprises a reactive hotmelt urethane adhesive.

13. The vehicular window assembly of claim 10, wherein the hotmelt adhesive comprises a reactive hotmelt one-component urethane adhesive.

14. The vehicular window assembly of claim 10, wherein the hotmelt adhesive comprises ADZ-1357.

15. The vehicular window assembly of claim 10, wherein the wall of said window component establishes a bond line thickness of the hotmelt adhesive.

16. The vehicular window assembly of claim 15, wherein the bond line thickness of the hotmelt adhesive is less than 1 mm.

17. A method of assembling a vehicular window assembly, said method comprising:
providing a window panel configured to be mounted at a vehicle, the window panel comprising a glass window panel;
providing a window component;
dispensing a hotmelt adhesive in its uncured state at one of the window panel and the window component;
positioning the window component at the window panel so that the hotmelt adhesive engages a surface of the window component and a surface of the window panel; and
curing the hotmelt adhesive to a solidified at least partially cured state to bond the window component to the window panel.

18. The method of claim 17, wherein said window component comprises a recess for receiving the hotmelt adhesive therein, and wherein the recess is established along an attaching surface of the window component with a wall of the window component at least partially circumscribing the recess, and wherein the wall of the window component establishes a bond line thickness of the hotmelt adhesive.

19. The method of claim 17, wherein curing the hotmelt adhesive comprises curing the hotmelt adhesive to a solidified at least partially cured state in less than two minutes.

20. The method of claim 17, wherein the hotmelt adhesive comprises a reactive hotmelt adhesive.

21. The method of claim 17, wherein the hotmelt adhesive comprises a reactive hotmelt urethane adhesive.

22. The method of claim 17, wherein the hotmelt adhesive comprises a reactive hotmelt one-component urethane adhesive.

23. The method of claim 17, wherein the hotmelt adhesive comprises ADZ-1357.

24. The method of claim 17, wherein the window component comprises a polymeric material.

25. The method of claim 17, wherein the window component comprises one selected from the group consisting of (i) a bracket, (ii) a hinge element for hingedly attaching the window panel at the vehicle, (iii) a latch element for latching the window panel at a closed position at the vehicle, (iv) a catch element for latching at a latch of another window panel of the vehicular window assembly, (v) a rail that receives a portion of a movable window panel that moves along the window panel.
